(19) United States
(12) Patent Application Publication
(10) Pub. No.: US 2011/0272236 A1
(43) Pub. Date: Nov. 10, 2011

(54) CLUTCH DEVICE

(75) Inventor: Masaharu OKAZAKI, Okayama-shi (JP)

(73) Assignee: Os Giken Co., Ltd., Okayama-shi (JP)

(21) Appl. No.: 12/974,274

(22) Filed: Dec. 21, 2010

(30) Foreign Application Priority Data
Mar. 12, 2010 (JP) 2010-056177

(51) Int. Cl. F16D 13/72; F16D 13/52; F16D 13/50

(52) U.S. Cl. 192/66.31

(57) ABSTRACT

There is provided a clutch device in which a half clutch range can be set at a wide range and in which smoothness and quickness in the disconnection of the clutch can be dramatically improved and in which a shift operation can be performed smoothly and quickly.

In a clutch device 1 in which clutch plates 5, 6 are sandwiched between a flywheel 10 and a pressure plate 23 to transmit a rotational force of an engine to a transmission, the pressure plate 23 is provided with an intermediate ring 24 which can be moved freely slightly in a direction in which the intermediate ring 24 is pressed by a diaphragm spring 21, and air passages 31 for making an inner peripheral side communicate with an outer peripheral side are formed between the intermediate ring 24 and the pressure plate 23 radially at specified intervals in a circumferential direction, and plate springs 25 for always biasing the intermediate ring 24 and the pressure plate 23 in a direction in which the intermediate ring 24 and the pressure plate 23 are separated from each other are fixed in the air passages 31, and the intermediate ring 24 is provided with spring members 40 for always biasing the diaphragm spring 21 to an abutting side in which the diaphragm spring 21 abuts against the intermediate ring 24.

### TECHNICAL FIELD

The present invention relates to a clutch device of an automobile which transmits a rotational force of an engine to a transmission and interrupts the transmission of the rotational force.

### BACKGROUND ART

As a clutch device of an automobile has been widely employed a clutch device which includes a pressure plate rotating integrally with a flywheel, a clutch plate rotating integrally with an input shaft of a transmission, and a diaphragm spring for biasing the pressure plate to the flywheel, and in which the clutch plate is sandwiched between the flywheel and the pressure plate by a biasing force of the diaphragm spring to transmit a rotational force of an engine to the transmission, and in which an operation of pressing the pressure plate by the biasing force of the diaphragm spring is released to freely rotate the clutch plate between the flywheel and the pressure plate to interrupt the transmission of the rotational force from the engine to the transmission.

In this regard, in a clutch device of an automobile designed for general purpose has been widely employed a clutch device in which a cushion plate is interposed between clutch plates to set a clutch pedal depressing range, in which a half clutch state can be provided, at a wide range in order to make a clutch operation smooth. However, in a clutch device of an automobile designed for a race, to perform a shift operation within a short time and to reduce the load of a transmission as much as possible, a cushion plate is omitted to reduce the inertial weight of the clutch plate as much as possible and hence a clutch pedal depressing range in which a half clutch state is provided (hereinafter simply referred to as “a half clutch range”) is made narrow. This presents a problem that when a clutch is connected, the clutch is connected rapidly more than expected to cause a shock.

Hence, to prevent the shock from being caused in this manner, there has been also proposed a clutch device in which a cushion ring is interposed between the pressure plate and a diaphragm spring, and in which a face on the cushion ring side of the pressure plate is constructed by a tapered face to form a clearance between the pressure plate and the inner peripheral portion of the cushion ring to make the cushion ring be elastically deformed to the pressure plate side by the use of the clearance, whereby a half clutch range is set at a wide range (see, for example, patent document 1).

However, in the clutch device as described in the patent document 1, the half clutch range is set at the wide range by the use of a spring force of the cushion ring, but the cushion ring and the pressure plate are formed in the shape of a ring and hence the air flow between the inner peripheral side and the outer peripheral side of the cushion ring and the pressure plate is interrupted. This presents a problem that the cushion ring is thermally degraded by the friction heat generated when the clutch is operated to reduce the spring ability of the cushion ring, whereby the half clutch range is made narrow within a short time.

Hence, the present applicant has proposed a clutch device in which a pressure plate is provided with an intermediate ring between the pressure plate and a diaphragm spring in such a way that the intermediate ring can be freely moved in a direction in which the intermediate ring is pressed by the diaphragm spring, and in which air passages for making an inner peripheral side communicate with an outer peripheral side are formed between the intermediate ring and the pressure plate at specified intervals in a circumferential direction, and in which each of the air passages has a plate spring fixed therein, the plate spring having both end portions to always bias the intermediate ring and the pressure plate in a direction in which the intermediate ring and the pressure plate are separated from each other and having one end portion fixed to the pressure plate and having other end portion made to abut against the intermediate ring, and in which a pressing force by the diaphragm spring is transmitted to the pressure plate via the intermediate ring and the plate springs.

### CITATION LIST

### Patent Literature

Patent document 1: JP-A No. 9-250556

However, even this clutch device presents a problem that when the clutch is disconnected, in some cases, the clutch causes a time lag in the disconnection of the clutch and hence cannot follow a quick shift operation and transmits offensive vibration of judder or the like to a clutch pedal. Further, this clutch device presents another problem that under severe conditions the pressure plate generates heat excessively and hence is thermally deformed and has the thermal deformation left thereon as a permanent strain to make the clutch resist being disconnected.

### SUMMARY OF INVENTION

### Technical Problem

The object of the present invention is to provide a clutch device in which a half clutch range can be set at a wide range for a long time and in which when the clutch is disconnected, smoothness and quickness in the disconnection of the clutch can be dramatically improved and hence a shift operation can be performed smoothly and quickly.

A clutch device according to the present invention is a clutch device which includes a pressure plate rotating integrally with a flywheel, a clutch plate rotating integrally with an input shaft of a transmission, and a diaphragm spring for biasing the pressure plate to the flywheel, and in which the clutch plate is sandwiched between the flywheel and the pressure plate by a biasing force of the diaphragm spring to transmit a rotational force of an engine to the transmission, and in which an operation of pressing the pressure plate by the biasing force of the diaphragm spring is released to freely rotate the clutch plate between the flywheel and the pressure plate to interrupt the transmission of the rotational force from the engine to the transmission. Further, the clutch device according to the present invention is characterized by the improvement wherein the pressure plate is provided with an intermediate ring between the pressure plate and the diaphragm spring in such a way that the intermediate ring can be freely moved in a direction in which the intermediate ring is pressed by the diaphragm spring, wherein air passages for making an inner peripheral side communicate with an outer peripheral side are formed between the intermediate ring and the pressure plate at specified intervals in a circumferential direction, wherein each of the air passages has a plate spring fitted therein, the plate spring having both end portions to always bias the intermediate ring and the pressure plate in a direction in which the intermediate ring and the pressure plate are separated from each other and having one end portion thereof fixed to one of the intermediate ring and the pressure plate and having other end portion thereof made to abut against other of the intermediate ring and the pressure plate, the other having the one end portion of the plate spring not fixed thereto, wherein the intermediate ring is provided with biasing means for always biasing the diaphragm spring to a side in which the diaphragm spring abuts against the intermediate ring, and wherein a pressing force by the diaphragm spring is transmitted to the pressure plate via the intermediate ring and the plate springs.

In this clutch device, in a state in which a clutch pedal is not depressed, the intermediate ring, the plate springs, and the pressure plate are integrally pressed to the flywheel by the biasing force of the diaphragm spring and the clutch plate is sandwiched between the pressure plate and the flywheel in a state where the clutch plate cannot slide on each other, whereby the clutch is connected and the rotational force of the engine is transmitted to the input shaft of the transmission. At this time, the plate springs are elastically deformed by the biasing force of the diaphragm spring, whereby the intermediate ring and the pressure plate are held in a state in which the intermediate ring and the pressure plate are close to each other.

On the other hand, when the clutch pedal is depressed, the diaphragm spring is separated from the intermediate ring to freely rotate the clutch plate between the pressure plate and the flywheel, whereby the clutch is disconnected and the rotational force of the engine is not transmitted to the transmission. At this time, the plate springs are going to return to their original shapes and hence the intermediate ring and the pressure plate are held in a state where the intermediate ring and the pressure plate are separated from each other.

Further, when the depressed clutch pedal is released, the intermediate ring, the plate springs, and the pressure plate are pressed to the flywheel by the diaphragm spring, whereby the clutch plates are first brought into sliding contact with the pressure plate and the flywheel to bring about a half clutch state in which a part of the rotational force is transmitted to the clutch plate. Then, when the depressed clutch pedal is further released, the plate springs are elastically deformed by the biasing force of the diaphragm spring, whereby the half clutch state is kept. Then, when the depressed clutch pedal is still further released, the clutch plates are sandwiched between the pressure plate and the flywheel in a state in which the clutch plates cannot slide, whereby the clutch is connected.

In this manner, in this clutch device, the half clutch state is produced by the diaphragm spring and the plate springs, so that as compared with a case where the half clutch state is produced only by the diaphragm spring, the half clutch range can be set at a wide range and hence the operability of the clutch when the clutch is connected can be improved and a shock caused by the sharp connection of the clutch can be effectively prevented. Further, since the air passages for making the inner peripheral side communicate with the outer peripheral side are formed between the intermediate ring and the pressure plate at specified intervals in the circumferential direction, when the intermediate ring and the pressure plate are rotated together with the flywheel, the air flow from the inner peripheral side to the outer peripheral side is formed in each of the air passages. Since the plate springs are fitted in the air passages, the plate springs can be effectively cooled by the air flowing in the air passages. Hence, this can prevent the plate springs from being thermally degraded by friction heat generated when the clutch is operated and can keep the half clutch range in a wide range for a long time and can effectively prevent the a shock from being caused by the sharp connection of the clutch for a long time.

Further, the intermediate ring is provided with the biasing means for always biasing the diaphragm spring to a side in which the diaphragm abuts against the intermediate ring, and the intermediate ring is moved integrally with the diaphragm spring by the biasing forces of the biasing means, so that smoothness and quickness in the disconnection of the clutch can be dramatically improved and hence a shift operation can be performed smoothly and quickly. Still further, since the shift operation can be performed smoothly and quickly, the transmission can be protected and the durability of the transmission can be improved and a quick shift operation can be reliably followed, which can contribute also to the shortening of time in a race or the like. Still further, the intermediate ring, the plate springs, and the pressure plate can be reliably moved, and when the clutch pedal is depressed, the clutch can be reliably disconnected, so that offensive vibration of judder or the like can be reliably absorbed by the elastic deformation of the plate springs, whereas when the foot is separated from the clutch pedal, the output of the engine can be reliably transmitted to the transmission. In this regard, the biasing means is not fixed to the intermediate ring but can be fixed also to the pressure plate, but in this case, the plate springs are elastically deformed by the biasing forces of the biasing means and hence the half clutch range is narrowed, and vibration of judder or the like is caused at the time of the half clutch operation as in the case of the conventional clutch device, and the operability of the clutch is reduced when the clutch is connected. Therefore, it is preferable that the biasing means are fitted to the intermediate ring so as not to affect the elastic deformation of the plate springs.

Here, a clutch device in which a clearance is formed between the intermediate ring and an obverse surface of each of the plate springs and a clearance is formed between the pressure plate and a reverse surface of each of the plate springs and in which each of the plate springs is arranged in each of the air passages is a preferred embodiment. In this case, the plate spring can be effectively cooled by setting the contact area of the plate spring and the air flowing in the air passage as large as possible. In this regard, the clutch device can be constructed so as to enhance heat radiation from the plate spring by forming depressions and protrusion or grooves on the obverse and reverse surfaces of the plate spring to increase the surface area of the plate spring.

A clutch device in which the one end portion of each of the plate springs is fixed to the pressure plate on a side closer to an outer periphery than the intermediate ring is also a preferred embodiment. In this case, since the air cooling of the portion of each of the plate springs in which the plate spring is fixed to the pressure plate can be accelerated, the plate spring can be prevented from being degraded by heat.

A clutch device in which steel balls are fixed in an embedded state in one of the intermediate ring and the pressure plate with a part of each of the steel balls protruded outward, and in which the other end portion of each of the plate springs is made to abut against each of the steel balls is also a preferred embodiment. According to this construction, the contact of the one of the intermediate ring and the pressure plate and the other end portion of the plate spring becomes a point contact by the steel ball, so that heat transmitted from the one of the intermediate ring and the pressure plate to the plate spring can be reduced as much as possible. Hence, this can more effectively prevent the plate springs from being thermally degraded by a temperature increase.

A clutch device in which the one end portion of each of the plate springs is fixed to one of the intermediate ring and the pressure plate on a side closer to an outer periphery than a sliding portion in which the clutch plate slides on the pressure plate is also a preferred embodiment. In this case, a portion of each of the plate springs in which the plate spring is fixed to the intermediate ring or the pressure plate is arranged at a portion closer to the outer peripheral side than the sliding portion which generates heat at the time of the half clutch operation, so that the transmission of heat to the plate spring can be reduced as much as possible, which can prevent the plate spring from being reduce in a spring ability by the thermal degradation of the plate spring. Here, it is preferable that the plate springs are fixed to the one of the intermediate ring and the pressure plate at positions as far as possible from the sliding portion.

A clutch device in which the intermediate ring has abutting portions, in which the intermediate ring abuts against the diaphragm spring, formed at specified intervals in a circumferential direction, each of the abutting portions being formed in a shape of a ring having an angular cross section, and in which air grooves for cooling the diaphragm spring are formed between the respective adjacent abutting portions, and in which the intermediate ring is coupled to the pressure plate in the air grooves is also a preferred embodiment. According to this construction, the intermediate ring can be fixed to the pressure plate with the bolts and rivets by the use of the air grooves formed in the intermediate ring, so that the structure of coupling the intermediate ring to the pressure plate can be formed without reducing the facility of assembling or working the clutch device.

The intermediate ring can have hook-shaped spring members fitted thereto as the biasing means at specified intervals in the circumferential direction, each of the hook-shaped spring members having one end thereof hooked on an outer peripheral portion of the diaphragm spring and having other end portion thereof fixed to the intermediate ring. When the hook-shaped spring members are used as the biasing means, the diaphragm spring can be fitted to the intermediate ring by engaging the outer peripheral portion of the diaphragm spring with the spring members while the spring members are elastically deformed in a state where the spring members are fitted to the intermediate ring. Hence, the facility of fitting the diaphragm spring to the intermediate ring can be improved. Further, since the spring members are fitted at specified intervals in the circumferential direction, the biasing forces of the spring members can be applied to the diaphragm spring in a good balance.

A clutch device in which the pressure plate has a ring-shaped inner peripheral portion formed in an inner peripheral portion thereof in a manner to protrude inside from an inner peripheral edge of a sliding portion in which the pressure plate slides on the clutch plate, the ring-shaped inner peripheral portion acting as a strain restraining portion for restraining a thermal strain of the pressure plate and having a cross-sectional area ranging from 1.6 t² or more to 3.0 t² or less where t is the thickness of the pressure plate is also a preferred embodiment. According to this construction, the inner peripheral portion of the pressure plate can be reinforced by the strain restraining portion. Hence, even when the clutch device is used under severe conditions in which the clutch operation is frequently performed as in the case of a race or the like, the pressure plate can be prevented from being deformed by heat into the shape of a disc spring. Hence, this can effectively prevent a malfunction that smoothness and quickness in the disconnection of the clutch is degraded by the thermal strain of the pressure plate.

### ADVANTAGEOUS EFFECTS OF THE INVENTION

According to the clutch device of the present invention, the half clutch state is produced by the diaphragm spring and the plate springs, so that as compared with a case where the half clutch state is produced only by the diaphragm spring, the half clutch range can be set at a wide range and hence the operability of the clutch when the clutch is connected can be improved and a shock caused by the sharp connection of the clutch can be effectively prevented. Further, since the air passages for making the inner peripheral side communicate with the outer peripheral side are formed between the intermediate ring and the pressure plate at specified intervals in the circumferential direction, when the intermediate ring and the pressure plate are rotated together with the flywheel, the air flow from the inner peripheral side to the outer peripheral side is formed in each of the air passages. Since the plate springs are fitted in the air passages, the plate springs can be effectively cooled by the air flowing in the air passages. Hence, this can prevent the plate springs from being thermally degraded by friction heat generated when the clutch is operated and can keep the half clutch range in a wide range for a long time and can effectively prevent the a shock from being caused by the sharp connection of the clutch for a long time.

Further, the intermediate ring is provided with the biasing means for always biasing the diaphragm spring to a side in which the diaphragm abuts against the intermediate ring, and the intermediate ring is moved integrally with the diaphragm spring by the biasing forces of the biasing means, so that smoothness and quickness in the disconnection of the clutch can be dramatically improved and hence a shift operation can be performed smoothly and quickly. Still further, since the shift operation can be performed smoothly and quickly, the transmission can be protected and the durability of the transmission can be improved and a quick shift operation can be reliably followed, which can contribute also to the shortening of time in a race or the like. Still further, the intermediate ring, the plate springs, and the pressure plate can be reliably moved, and when the clutch pedal is depressed, the clutch can be reliably disconnected, so that offensive vibration of judder or the like can be reliably absorbed by the elastic deformation of the plate springs, whereas when the foot is separated from the clutch pedal, the output of the engine can be reliably transmitted to the transmission.

### BRIEF DESCRIPTION OF THE DRAWINGS

FIG. 1 is a longitudinal cross-sectional view of a clutch device.

FIG. 2 is an exploded perspective view of a pressure plate assembly.

FIG. 3 is a front view of the pressure plate assembly.

FIG. 4 is a cross-sectional view taken on a line IV-IV of FIG. 3.

FIG. 5 is a cross-sectional view taken on a line V-V of FIG. 3.

FIG. 6 is a cross-sectional view taken on a line VI-VI of FIG. 3.

FIG. 7 is a front view of a pressure plate.

FIG. 8 is a rear view of an intermediate ring.

### DESCRIPTION OF EMBODIMENT

Hereinafter, an embodiment of the present invention will be described with reference to the drawings. In this embodiment, the description will be provided with a front and rear direction defined as follows: an engine side is defined as a front side and a transmission side is defined as a rear side.

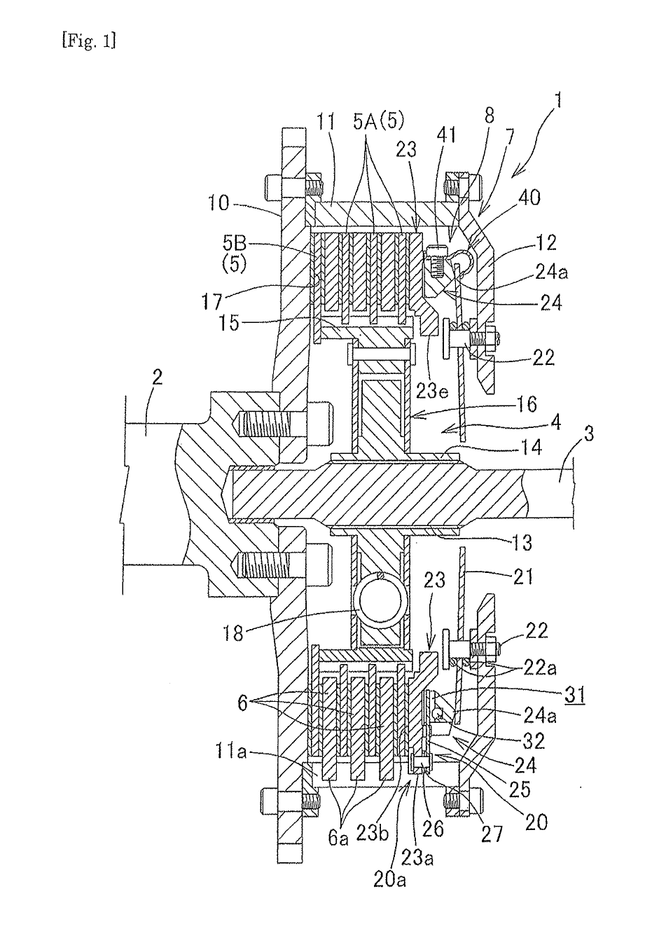

As shown in FIG. 1, a clutch device 1 is a device for connecting or disconnecting the rotational force of the crankshaft 2 to or from the input shaft 3 between a crankshaft 2 of an engine and an input shaft 3 of a transmission. The clutch device 1 is provided with: a plurality of inner clutch plates 5 fitted to the input shaft 3 via a disk support member 4 in such a way as to freely move in an axial direction and not to rotate relatively to each other; a plurality of outer clutch plates 6 each of which is arranged between adjacent inner clutch plates 5 and fitted to a clutch housing 7 rotating with the crankshaft 2 in such a way as to freely move in the axial direction and not to rotate relatively to each other; and an operation means 8 for operating the clutch plates 5, 6 in the axial direction at a connection position in which the clutch plates 5, 6 are pressed on each other and at a disconnection position in which the clutch plates 5, 6 are separated from each other, and is constructed in the following way. Here, in this embodiment will be described a case in which the present invention is applied to the multi-plate clutch device 1 provided with the plurality of inner clutch plates 5 and the plurality of outer clutch plates 6. However, the present invention can be applied in a like manner also to a single-pate clutch device constructed in such a way that one inner clutch plate is sandwiched between a flywheel and a pressure plate 23.

A flywheel 10, which is formed nearly in the shape of a circular disk, is fixed by bolts to a rear end portion of the crankshaft 2, and a housing 11, which is protruded rearward and is formed nearly in the shape of a cylinder, is fixed to a portion close to the outer periphery of the flywheel 10, and a cover member 12, which is extended to an inner peripheral side of the housing 11 and is formed in the shape of a ring, is fixed to a rear end portion of the housing 11. The clutch housing 7 is constructed of the flywheel 10, the housing 11, and the cover member 12 and is fixed to the rear end portion of the crankshaft 2 and is constructed in such a way as to rotate integrally with the crankshaft 2.

A front end portion of the input shaft 3 is inserted into the clutch housing 7 and is rotatably fitted in a central portion of the rear end of the crankshaft 2, and a spline shaft portion 13 is formed in a portion close to the front end of the input shaft 3 in the clutch housing 7.

The disk support member 4 is provided with: a center boss 14 that fits on the spline shaft portion 13 of the input shaft 3 in such a way as to freely move in the axial direction and not to rotate relatively to each other; a ring gear 15 fixed to the center boss 14 in such a way as not to move in the axial direction and to rotate relatively to each other within a range of a specified angle; and a cushion means 16 for cushioning a rotational force from the ring gear 15 to the center boss 14. In this regard, as for a fitting structure of the center boss 14 and the input shaft 3, an arbitrary fitting structure of a spline fitting structure, a fitting structure using a key and a key groove, or the like can be employed, if the fitting structure allows the center boss 14 and the input shaft 3 to move in the axial direction relatively to each other and does not allow the center boss 14 and the input shaft 3 to rotate relatively to each other. Moreover, the cushion means 16 has a well-known construction such that a variation in the rotational force from the inner clutch plate 5 to the input shaft 3 is cushioned by a spring member 18 made of a compression coil spring. However, it is also possible to omit this cushion means 16 and to couple the center boss 14 integrally to the ring gear 15.

The ring gear 15 of the disk support member 4 has three first inner clutch plates 5A fitted thereto in such a way that the first inner clutch plates 5A can freely move in the axial direction and cannot to rotate relatively to each other, and the ring gear 15 has one second inner clutch plate 5B fixed to a front end portion thereof with bolts, screws, welding, or the like. Since the one second inner clutch plate 5B is fixed to the ring gear 15 in this manner, the ring gear 15 is restrained from moving in the axial direction relatively to the second inner clutch 5B in the state in which the clutch device 1 is fitted as shown in FIG. 1, whereby the inner clutch plates 5 are prevented from falling out of the front side of the ring gear 15. Moreover, since the second inner clutch plate 5B is fixed to the ring gear 15, a backlash between the ring gear 15 and the inner clutch plates 5 is prevented to enhance the operability of a clutch. However, as for the fitting structure of the ring gear 15 and the first inner clutch plates 5A, an arbitrary fitting structure of a spline fitting structure, a fitting structure using a key and a key groove, or the like can be employed, if the fitting structure allows the ring gear 15 and the first inner clutch plates 5A to move in the axial direction relatively to each other and does not allow the ring gear 15 and the first inner clutch plates 5A to rotate relatively to each other.

The outer clutch plates 6, each of which is shaped like a ring, are fitted between adjacent inner clutch plates 5, and slits 11a extending in the axial direction are formed in the housing 11 at regular intervals in the circumferential direction, and fitting protrusions 6a to be fitted in the slits 11a are formed in the outer peripheral portions of three outer clutch plates 6, and the fitting protrusions 6a are fitted in the slits 11a, whereby the outer clutch plates 6 are fitted in the housing 11 in such a way as to move in the axial direction and not to rotate relatively to each other. As for the fitting structure of the outer clutch plates 6 and the housing 11, an arbitrary fitting structure of a spline fitting structure, a fitting structure using a key and a key groove, or the like can be employed, if the fitting structure allows the outer clutch plates 6 and the housing 11 to move in the axial direction relatively to each other and does not allow the outer clutch plates 6 and the housing 11 to rotate relatively to each other.

The number of the inner clutch plates 5 can be set at an arbitrary number, and the number of the outer clutch plates is set at a number smaller than the number of the inner clutch plates 5 by one. When the number of the inner clutch plates 5 is set at a number more than 5, these clutch plates 5, 6 cannot fitted in an existing housing 11, so that it is preferable that the number of the inner clutch plates is set at a number from 2 to 4.

The operation means 8 for switching the clutch plates 5, 6 between a connection state and a disconnection state will be described. As shown in FIG. 1, a ring-shaped receiving face 17 is formed on the flywheel 10 so as to be opposite to the second inner clutch plate 5B, and a ring-shaped pressure plate assembly 20 for operating the inner clutch plates 5 to the flywheel 10 is fitted between the cover member 12 and the inner clutch plates 5. The pressure plate assembly 20 has fitting protrusions 20a formed in the outer peripheral portion thereof, the fitting protrusions 20a being fitted respectively in the slits 11a of the housing 11. The pressure plate assembly 20 is fitted in the housing 11 in such a way as to freely move in the axial direction and not to rotate relatively to each other. The cover member 12 has a diaphragm spring 21 fixed to a front side thereof via a plurality of support pins 22, and the pressure plate assembly 20 is always biased to the clutch plates 5, 6 by the diaphragm spring 21, whereby the clutch plates 5, 6 are sandwiched between the pressure plate assembly 20 and the receiving face 17 and are held in a state in which the clutch is connected.

The input shaft 3 has an operation member (not shown in the drawing) fitted thereon externally in such a way as to freely move in the axial direction on the rear side of the diaphragm spring 21, and when a clutch pedal is depressed, the operation member is moved forward to operate the inner peripheral portion of the diaphragm spring 21 to the flywheel 10 side, whereby the diaphragm spring 21 is warped back with a center at a pair of front and rear diaphragm rings 22a fitted on the outer peripheral side of the support pins 22 to separate the outer peripheral portion of the diaphragm spring 21 from the abutting portions 24.a of the pressure plate assembly 20 to bring the clutch plates 5, 6 into a state in which the clutch is disconnected.

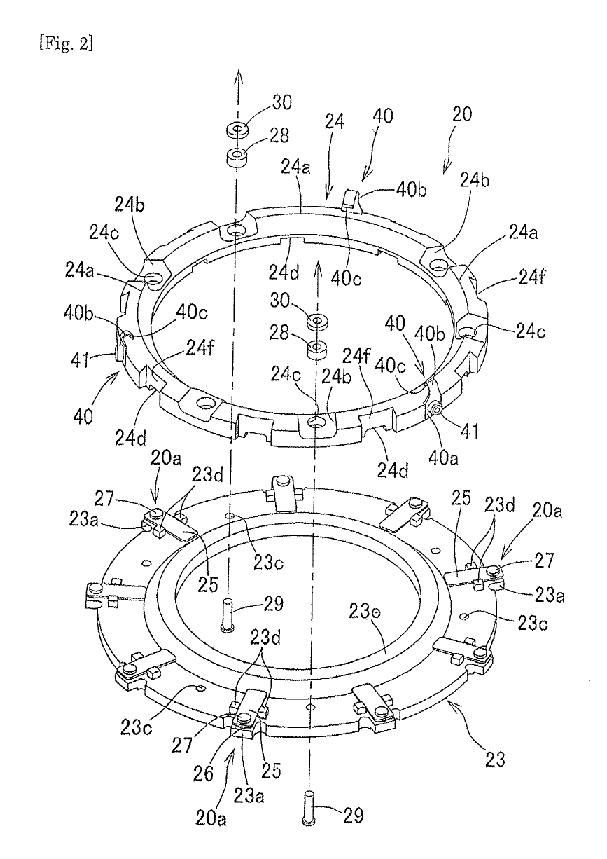

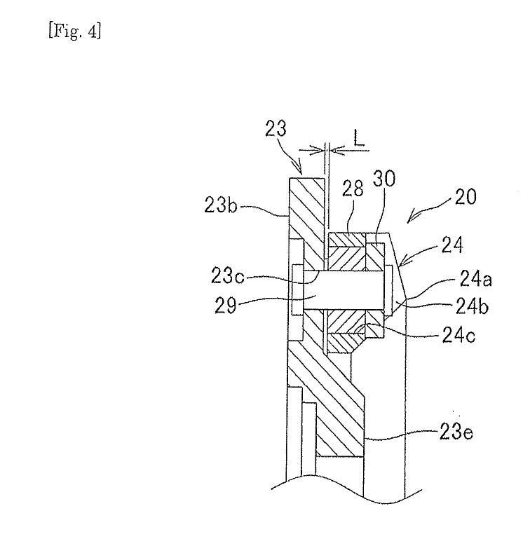

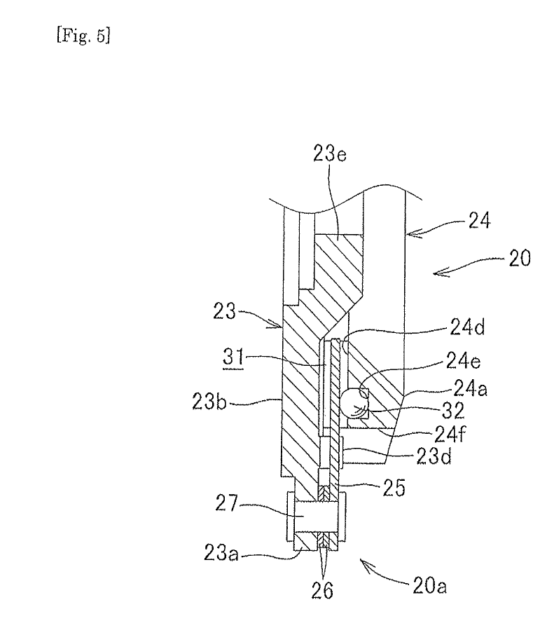

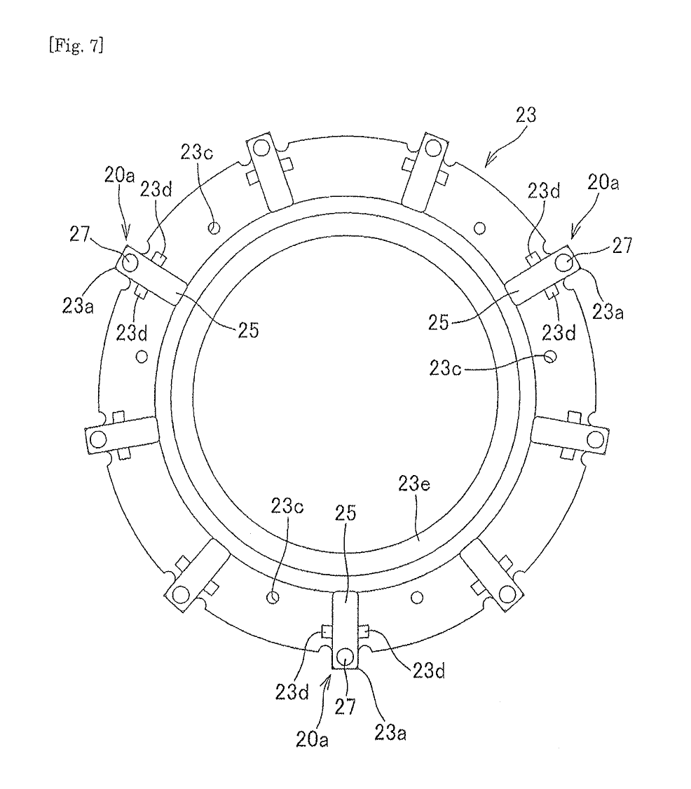

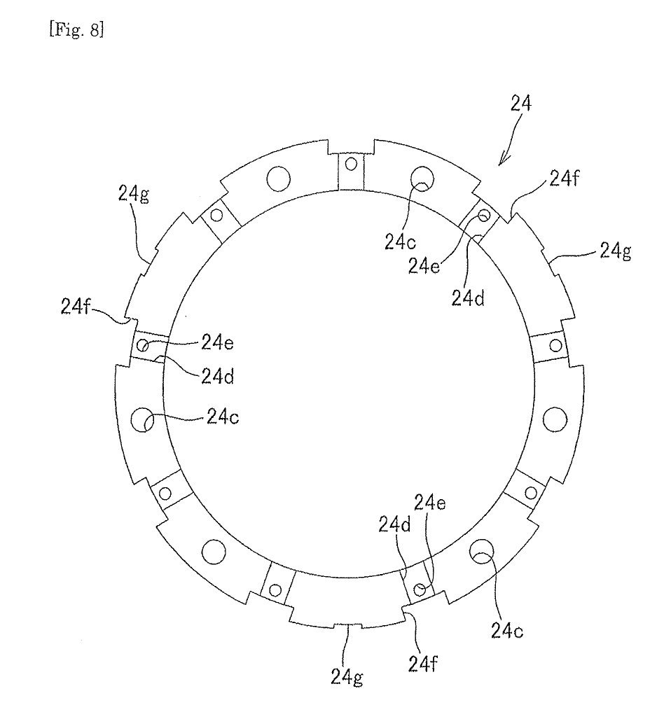

The pressure plate assembly 20, as shown in FIG. 1 to FIG. 8, is provided with: a pressure plate 23; an intermediate ring 24 fitted on the rear side of the pressure plate 23 so as to freely move slightly in a direction in which the intermediate ring 24 is pressed by the diaphragm spring 21 (in a front and rear direction); plate springs 25 for always biasing the intermediate ring 24 and the pressure plate 23 in a direction in which the intermediate ring 24 and the pressure plate 23 are separated from each other; and spring members 40 as biasing means for always biasing the outer peripheral portion of the diaphragm spring 21 to a side in which the outer peripheral portion of the diaphragm spring 21 abuts against the intermediate ring 24.

The pressure plate 23 is constructed of a ring-shaped member formed nearly in the shape of a flat plate. The pressure plate 23 has fitting protrusions 23a formed in the outer peripheral portion thereof in a protruding manner at specified intervals in the circumferential direction, the fitting protrusions 23a being fitted in the slits 11a of the housing 11. The pressure plate 23 has a pressing face 23b fitted on the front surface thereof so as to be opposite to the inner clutch plate 5 at a rear end portion, the pressing face 23b being formed nearly in a flat shape and to be pressed to the inner clutch plate 5. The pressure plate 23 has the plate springs 25 fitted to the rear surface thereof radially in a radial direction at specified intervals in the circumferential direction in correspondence to the fitting protrusions 23a of the pressure plate 23, each of the plate springs 25 having both ends and a rectangular shape. The pressure plate 23 has positioning protrusions 23d formed on a rear surface thereof in a manner protruding rearward at specified intervals in the circumferential direction, the positioning protrusions 23d being arranged on both sides of each of the plate springs 25 and positioning each of the plate springs 25 in the circumferential direction of the pressure plate 23 and positioning the intermediate ring 24 concentrically with respect to the plate springs 25. The outer peripheral end portion of each of the plate springs 25 is fixed to each of the fitting protrusions 23a with a rivet 27 via a washer 26, and each of the plate springs 25 is supported in the manner of a cantilever at specified intervals with respect to the rear surface of the pressure plate 23 via the washer 26. In this manner, each of the plate springs 25 is fixed to each of the fitting protrusions 23a, so that each of the plate springs 25 can be fixed by the use of a dead space in each of the slits 11a formed in the housing 11. Further, the fixed portion of each of the plate springs 25 is arranged at a position separate as far as possible from a sliding portion of the clutch plate 6 heating in the state of half clutch, so that the heat transferred to the plate springs 25 can be reduced as much as possible and hence the plate springs 25 can be prevented from being reduced in a spring ability by the thermal degradation.

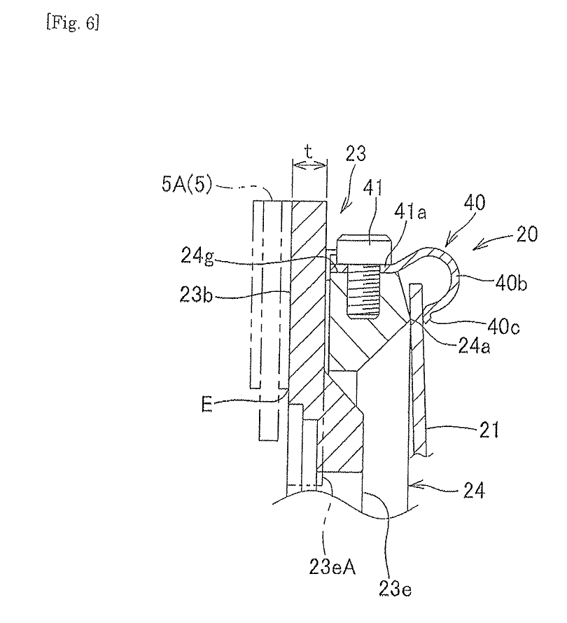

The pressure plate 23 has a ring-shaped inner peripheral portion formed on an inner peripheral portion thereof, the ring-shape inner peripheral portion protruding inside from an inner peripheral edge E of a sliding portion of the pressure plate 23 in which the pressure plate 23 slides on the clutch plate 5A and acting as a strain restraining portion 23e for restraining the pressure plate 23 from being strained by the heat. As for the cross-sectional area in the radial direction of the pressure plate 23 of the strain restraining portion 23e protruding inside from the inner peripheral edge E of the sliding portion, when the cross-sectional area of the strain restraining portion 23e is too large, the pressure plate 23 interferes with the disk support member 4 or the like whereas when the cross-sectional area of the strain restraining portion 23e is too small, the pressure plate 23 cannot produce a sufficient effect of restraining heat strain. Hence, the cross-sectional area of the strain restraining portion 23e is preferably set at a range from 1.6 t² to 3.0 t², more preferably, from 2.0 t² to 2.5 where the thickness of the sliding portion of the pressure plate 23 is t. By the use of this construction, the inner peripheral portion of the pressure plate 23 has its strength and rigidity increased by the strain restraining portion 23e, so that even when the clutch device 1 is used under severe conditions in which the clutch operation is frequently performed as in the case of a race or the like, the pressure plate 23 can be prevented from being thermally deformed in the shape of a disc spring (frustum of circular cone), which can effectively prevent a malfunction that smoothness and quickness in the disconnection of the clutch are reduced by the thermal strain of the pressure plate 23. Here, the strain restraining portion 23e, as shown by a solid line in FIG. 6, can be provided in such a way as to protrude toward the diaphragm spring 21 from the inner peripheral edge E of the sliding portion in which the pressure plate 23 slides on the clutch plate 5A in order to avoid interfering with the disk support member 4, or the strain restraining portion 23e, like a strain restraining portion 23eA shown by an imaginary line in FIG. 6, can be also arranged on the same plane as the sliding portion in which the pressure plate 23 slides on the clutch plate 5A. In this regard, it is preferable that this strain restraining portion 23e is fitted in the clutch device of a car used under severe conditions in which the clutch is connected or disconnected very frequently like a racing car, but the strain restraining portion 23e can be also omitted in the clutch device mounted on a general purpose car.

The pressure plate 23 has the ring-shaped intermediate ring 24 fitted on the outer peripheral side of the rear surface thereof, and the intermediate ring 24 has abutting portions 24a formed on the rear surface side thereof in a manner protruding rearward at specified intervals in a circumferential direction, the abutting portion 24a being formed in the shape of a ring having an angular cross section and having its tip portion (rear end portion) arranged in such a way as to be pressed onto the outer peripheral portion of the diaphragm spring 21. An air groove 24b is formed between the adjacent abutting portions 24a, and a air flow from the inner peripheral side to the outer peripheral side of the intermediate ring 24 is formed in the air groove 24b by the centrifugal force produced by the rotation of the intermediate ring 24, and the diaphragm spring 21 can be cooled by the air flow. The intermediate ring 24 has a fixing hole 24c formed in the air groove 24b. The pressure plate 23 has a through hole 23c formed therein in correspondence to the fixing hole 24c, the through hole 23c having a diameter smaller than the fixing hole 24c. The fixing hole 24c has a sleeve 28 fitted therein, the sleeve 28 having a specified length. The intermediate ring 24 and the pressure plate 23 are coupled to each other by a rivet 29 passing through the sleeve 28 and the through hole 23c in such a way as to move freely slightly by a distance L in the direction in which the diaphragm spring 21 presses the pressure plate 23 (in the front and rear direction), the distance L being the result of subtraction of the depth of the fixing hole 24c from the length of the sleeve 28. Here, a reference number 30 designates a metal washer for preventing the rivet 29 from falling out, and this metal washer 30 can be also omitted by forming a collar portion in the end portion of the sleeve 28.

The intermediate ring 24 has fitting grooves 24f formed at specified intervals in the circumferential direction in correspondence to the plate springs 25, and the intermediate ring 24 is positioned in the circumferential direction of the pressure plate 23 by fitting the positioning protrusions 23d of the pressure plate 23, which are arranged on both sides of each of the plate springs 25, in the fitting grooves 24f. The intermediate ring 24 has grooves 24d formed on the front side thereof at specified intervals in the circumferential direction in correspondence to the plate springs 25, each of the grooves 24d extending in the radial direction, and in a state where the intermediate ring 24 is fitted to the pressure plate 23, an air passage 31 in which the plate spring 25 is passed is formed between the intermediate ring 24 and the pressure plate 23 by each of the grooves 24d. The intermediate ring 24 has fixing bores 24e formed therein in such a way that each of the fixing bores 24e opens toward the central portion of each of the grooves 24d, each of the fixing bores 24e being formed in the front and rear direction and closed at one end. Each of the fixing bores 24e has a steel ball 32 fixed therein in a state in which the steel ball 32 is embedded with a part of the steel ball 32 protruded forward. In a state where the intermediate ring 24 is fixed to the pressure plate 23 by the rivets 29, the other end portions of the plate springs 25 are pressed on the steel balls 32, whereby the intermediate ring 24 and the pressure plate 23 are always biased in a direction in which the intermediate ring 24 and the pressure plate 23 are separated from each other. Moreover, in a state where the plate springs 25 are fitted between the intermediate ring 24 and the pressure plate 23, the plate springs 25 are brought into contact with the pressure plate 23 via the rivets 27 and the washers 26 and are brought into point contact with intermediate ring 24 via the steel balls 32, but the other portions of the plate springs 25 are arranged so as to separate from the pressure plate 23 and the intermediate ring 24, whereby heat transmitted to the plate springs 25 is decreased as much as possible. On the other hand, the air flow from the inner peripheral side to the outer peripheral side of the intermediate ring 24 and the pressure plate 23 is formed in each of the air passages 31 by the centrifugal force produced by the rotation of the intermediate ring 24, whereby the plate springs 25 can be effectively cooled by the air flow.

In this regard, in this embodiment, the outer peripheral end of each of the plate springs 25 is fixed to the pressure plate 23, but each of the plate springs 25 can be also supported in the manner of a cantilever with respect to the pressure plate 23 by fixing the inner peripheral end of each of the plate springs 25 to the pressure plate 23. Moreover, the plate springs 25 are fixed to the pressure plate 23 radially in the radial direction, but the plate springs 25 can be also arranged on the slant to the radial direction or in the circumferential direction. Further, in place of the steel balls 32, the intermediate ring 24 can have protrusions formed thereon, each of the protrusions abutting against each of the plate springs 25. Still further, it is also possible that the plate springs 25 are fixed to the intermediate ring 24 and that the pressure plate 23 has the steel balls 32 fixed thereto, each of the steel balls 32 abutting against the end portion of each of the plate springs 25. Still further, in the case where as the fitting structure of the outer clutch plates 6 and the pressure plate 23, and the housing 11, the housing 11 has protrusions formed on the inner peripheral surface thereof in a manner protruding inside, each of the protrusions extending in the front and rear direction, and the outer clutch plates 6 and the pressure plate 23 have grooves formed thereon, each of the grooves having each of the protrusions fitted therein, the outer peripheral end portions of the plate springs 25 are fixed to the protruding portions for forming the grooves of the pressure plate 23.

The intermediate ring 24 has fixing grooves 24g formed in the outer peripheral portion thereof between the adjacent fitting grooves 24f, and each of the fixing grooves 24g has each of the spring members 40 fixed therein, the spring members 40 always biasing the outer peripheral portion of the diaphragm spring 21 to a side in which the diaphragm spring 21 abuts against the intermediate ring 24. The spring member 40 is constructed of a plate spring having: a fixing portion 40a fixed to the outer peripheral surface of the intermediate ring 24 with a bolt member 41; a hook portion 40b extended rearward form the fixing portion 40a and curved to the central portion side of the intermediate ring 24; and an abutting portion 40c formed by curving the tip of the hook portion 40b rearward. This spring member 40 is fixed to the intermediate ring 24 with the bolt member 41 in a state where the fixing portion 40a is fitted in the fixing groove 24g, and the diaphragm spring 21 is fitted inside three spring members 40 from the rear side to hook the tips of the hook portions 40b on the rear surface of the outer peripheral portion of the diaphragm spring 21 to sandwich the outer peripheral portion of the diaphragm spring 21 between the abutting portions 24a of the intermediate ring 24 and the abutting portions 40c of the spring members 40, whereby the outer peripheral portion of the diaphragm spring 21 is always biased to a side in which the diaphragm spring 21 abuts against the intermediate ring 24. However, as for the spring member 40, a member having any arbitrary construction can be employed, if the member can bias the outer peripheral portion of the diaphragm spring 21 to the intermediate ring 24. Further, the diaphragm spring 21 can have holes or the like formed therein, each of the holes or the like having the tip of each of the hook portions 40b fitted therein.

As for the number of the spring members 40, an arbitrary number of spring members 40 can be employed, if the arbitrary number of spring members 40 can apply biasing forces in good balance in the circumferential direction of the diaphragm spring 21. However, when the spring members 40 increases in number, the manufacturing cost increases and the fixing work becomes cumbersome. Hence, for example, three to six spring members 40 are fixed to the outer peripheral portion of the intermediate ring 24 at specified intervals in the circumferential direction.

Next, the action of the clutch device 1 will be described.

In a state where a clutch pedal is not depressed, the intermediate ring 24, the plate springs 25, and the pressure plate 23 are integrally pressed onto the flywheel 10 by the biasing force of the diaphragm spring 21 and hence the clutch plates 5, 6 are sandwiched between the pressure plate 23 and the flywheel 10 so as not to slide on each other, whereby the clutch is connected and hence the rotational force of the engine is transmitted to the input shaft 3 of the transmission. At this time, the plate springs 25 are elastically deformed by the biasing force of the diaphragm spring 21, whereby the intermediate ring 24 and the pressure plate 23 are held in a state where the intermediate ring 24 and the pressure plate 23 are close to each other.

On the other hand, when the clutch pedal is depressed, the diaphragm spring 21 is separated from the intermediate ring 24 and hence the clutch plates 6 are freely rotated between the pressure plate 23 and the flywheel 10 and the clutch is disconnected, which results in stopping the rotational force of the engine from being transmitted to the transmission side. At this time, the plate springs 25 will return to their original shapes, whereby the intermediate ring 24 and the pressure plate 23 are held in a separate state.

Further, when the depressed clutch pedal is released, the intermediate ring 24, the plate springs 25, and the pressure plate 23 are pressed onto the flywheel 10 by the diaphragm spring 21, whereby the inner clutch plates 5 are first brought into sliding contact with the outer clutch plates 6 between the pressure plate 23 and the flywheel 10 to bring about a half clutch state in which a part of the rotational force of the engine is transmitted to the inner clutch plates 5. When the clutch pedal is further released, the plate springs 25 are elastically deformed by the biasing force of the diaphragm spring 21, whereby the half clutch state is kept. When the clutch pedal is still further released, the clutch plates 5, 6 are sandwiched between the pressure plate 23 and the flywheel 10 in such a way as not to slide on each other, whereby the clutch is connected.

Further, when the clutch pedal is depressed, the pressure plate assembly 20 is integrally moved smoothly rearward together with the outer peripheral portion of the diaphragm spring 21 via the spring members 40 to form a clearance between the pressure plate 23 and the clutch plate to rotate the clutch plates 6 freely, smoothly, and quickly, whereby smoothness and quickness in the disconnection of the clutch can be dramatically improved and a shift operation can be performed smoothly and quickly.

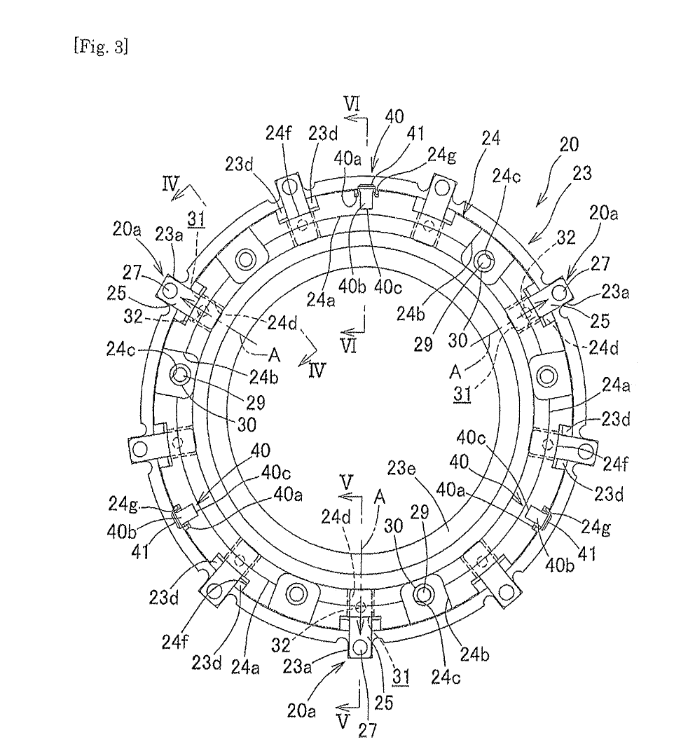

In this manner, in this clutch device 1, the half clutch state is formed by the diaphragm spring 21 and the plate springs 25, so that as compared with a case where the half clutch state is formed only by the diaphragm spring 21, a half clutch range can be set at a wide range and hence operability at the time when the clutch is connected can be improved to effectively prevent a shock from being caused when the clutch is sharply connected. In addition, the air passages 31 for making the inner peripheral side communicate with the outer peripheral side are formed between the intermediate ring 24 and the pressure plate 23 at specified intervals in the circumferential direction, so that when the intermediate ring 24 and the pressure plate 23 rotate with the flywheel 10, as shown by an arrow A in FIG. 3, an air flow from the inner peripheral side to the outer peripheral side is formed in the air passages 31, and the plate springs 25 are fitted in the air passages 31, so that the plate springs 25 can be effectively cooled by the air flowing in the air passages 31. This can effectively prevent the plate springs 25 from being thermally degraded by friction heat when the clutch is operated to keep the half clutch rage in a wide range for a long time, whereby the shock caused when the clutch is sharply connected can be prevented effectively for a long time Here, the number of the plate springs 25, the width, length, and thickness of the plate spring 25, and the spring constant of the plate spring 25 are set at values to produce the half clutch state by the elastic deformation of the plate spring 25.

Further, the intermediate ring 24 is moved integrally with the diaphragm spring 21 by the biasing force of the spring members 40, so that smoothness and quickness in the disconnection of the clutch can be dramatically improved and the shift operation can be smoothly and quickly. Still further, since the shift operation can be performed smoothly and quickly, the transmission can be protected and the durability of the transmission can be improved, and the clutch can reliably follow also a quick shift operation, which can hence contribute also to shortening time in a race or the like. Still further, the action of the pressure plate assembly 20 can be reliably performed, so that when the clutch pedal is depressed, the clutch can be surely disconnected to absorb the uncomfortable vibration of judder or the like by the elastic deformation of the plate springs 25, and when the foot is separated from the clutch pedal, the power of the engine can be reliably transmitted to the transmission.

Up to this point, the embodiment of the present invention has been described. However, the present invention is not limited to the embodiment described above, but needless to say, the construction of the present invention can be modified within a range not departing from the gist of the present invention.

### REFERENCE SIGNS LIST

1 Clutch device
2 Crankshaft
3 Input shaft
4 Disk support member
5 Inner clutch plate
5A Inner clutch plate
5B Inner clutch plate
6 Outer clutch plate
6a Fitting protrusion
7 Clutch housing
8 Operation means
10 Flywheel
11 Housing
11a Slit
12 Cover member
13 Spline shaft portion
14 Center boss
15 Ring gear
16 Cushion means
17 Receiving face
18 Spring member
20 Pressure plate assembly
20a Fitting protrusion
21 Diaphragm spring
22 Support pin
22a Diaphragm ring
23 Pressure plate
23a Fitting protrusion
23b Pressing face
23c Through hole
23d Positioning protrusion
23e Strain restraining portion
23eA Strain restraining portion
24 Intermediate ring
24a Abutting portion
24b Air groove
24c Fixing hole
24d Groove
24e Fixing bore
24f Fitting groove
24g Fixing groove
25 Plate spring
26 Washer
27 Rivet
28 Sleeve
29 Rivet
30 Washer
31 Air passage
32 Steel ball
40 Spring member
40a Fixing portion
40b Hook portion
40c Abutting portion
41 Bolt member

1. A clutch device comprising a pressure plate rotating integrally with a flywheel, a clutch plate rotating integrally with an input shaft of a transmission, and a diaphragm spring for biasing the pressure plate to the flywheel, and in which the clutch plate is sandwiched between the flywheel and the pressure plate by a biasing force of the diaphragm spring to transmit a rotational force of an engine to the transmission, and in which an operation of pressing the pressure plate by the biasing force of the diaphragm spring is released to freely rotate the clutch plate between the flywheel and the pressure plate to interrupt the transmission of the rotational force from the engine to the transmission,
wherein the pressure plate is provided with an intermediate ring between the pressure plate and the diaphragm spring in such a way that the intermediate ring can be freely moved in a direction in which the intermediate ring is pressed by the diaphragm spring,
wherein air passages for making an inner peripheral side communicate with an outer peripheral side are formed between the intermediate ring and the pressure plate at specified intervals in a circumferential direction,
wherein each of the air passages has a plate spring fitted therein, the plate spring having both end portions to always bias the intermediate ring and the pressure plate in a direction in which the intermediate ring and the pressure plate are separated from each other and having one end portion thereof fixed to one of the intermediate ring and the pressure plate and having other end portion thereof made to abut against other of the intermediate ring and the pressure plate, the other having the one end portion of the plate spring not fixed thereto,
wherein the intermediate ring is provided with biasing means for always biasing the diaphragm spring to a side in which the diaphragm spring abuts against the intermediate ring, and
wherein a pressing force by the diaphragm spring is transmitted to the pressure plate via the intermediate ring and the plate springs.

2. The clutch device according to claim 1,
wherein a clearance is formed between the intermediate ring and an obverse surface of each of the plate springs and a clearance is formed between the pressure plate and a reverse surface of each of the plate springs, and
wherein each of the plate springs is arranged in each of the air passages.

3. The clutch device according to claim 1 or 2,
wherein the one end portion of each of the plate springs is fixed to the pressure plate on a side closer to an outer periphery than the intermediate ring.

4. The clutch device according to claim 1 or 2,
wherein steel balls are fixed in an embedded state in one of the intermediate ring and the pressure plate with a part of each of the steel balls protruded outward, and
wherein the other end portion of each of the plate springs is made to abut against each of the steel balls.

5. The clutch device according to claim 1 or 2,
wherein the one end portion of each of the plate springs is fixed to one of the intermediate ring and the pressure plate on a side closer to an outer periphery than a sliding portion in which the clutch plate slides on the pressure plate.

6. The clutch device according to claim 1 or 2,
wherein the intermediate ring has abutting portions, in which the intermediate ring abuts against the diaphragm spring, formed at specified intervals in a circumferential direction, each of the abutting portions being formed in a shape of a ring having an angular cross section,
wherein air grooves for cooling the diaphragm spring are formed between the respective adjacent abutting portions, and
wherein the intermediate ring is coupled to the pressure plate in the air grooves.

7. The clutch device according to claim 1 or 2,
wherein the intermediate ring has hook-shaped spring members fitted thereto as the biasing means at specified intervals in the circumferential direction, each of the hook-shaped spring members having one end thereof hooked on an outer peripheral portion of the diaphragm spring and having other end portion thereof fixed to the intermediate ring.

8. The clutch device according to claim 1 or 2,
wherein the pressure plate has a ring-shaped inner peripheral portion formed in an inner peripheral portion thereof in a manner to protrude inside from an inner peripheral edge of a sliding portion in which the pressure plate slides on the clutch plate, the ring-shaped inner peripheral portion acting as a strain restraining portion for restraining a thermal strain of the pressure plate and having a cross-sectional area ranging from 1.6 t² or more to 3.0 t² or less where t is the thickness of the pressure plate.
